(19) United States
(12) Patent Application Publication
(10) Pub. No.: US 2015/0123760 A1
(43) Pub. Date: May 7, 2015

(54) METHOD AND DESIGN FOR STABILIZING CONDUCTORS IN A COIL WINDING

(71) Applicant: ADVANCED MAGNET LAB, INC., Palm Bay, FL (US)

(72) Inventor: Rainer Meinke, Melbourne, FL (US)

(73) Assignee: ADVANCED MAGNET LAB, INC., Palm Bay, FL (US)

(21) Appl. No.: 14/515,695

(22) Filed: Oct. 16, 2014

Related U.S. Application Data
(60) Provisional application No. 61/891,849, filed on Oct. 16, 2013.

(51) Int. Cl. H01F 5/02

(52) U.S. Cl. CPC H01F 5/02
USPC 336/208

(57) ABSTRACT

A wiring assembly having a support structure with a surface region formed about a central axis. In one embodiment, a groove formed in the surface region has first and second opposing wall portions each extending inward toward the central axis, and a length of conductor is positioned in the groove to extend along the groove. A sheet of material is positioned about a portion of the conductor, and a continuous medium extends from one of the groove wall portions to the sheet.

### PRIORITY BASED ON RELATED APPLICATION

This application claims priority based on U.S. Provisional Application No. 61/891,849 filed Oct. 16, 2013.

### FIELD OF THE INVENTION

The present invention relates to electrical systems and associated methods of operation and, in one series of embodiments, the invention relates to electromagnetic systems, including systems which generate magnetic fields, systems which incorporate motors, and magnets generally. More particularly, the disclosed embodiments relate to systems comprising conductor assemblies which, when conducting current, generate a magnetic field or which, in the presence of a changing magnetic field, induce a voltage. Although not limited to such, the invention has application in superconducting windings.

### BACKGROUND OF THE INVENTION

Numerous configurations have been proposed to define winding paths in coils to provide desired magnetic field characteristics. The following disclosures, incorporated herein by reference, teach formation of a groove which defines a desired winding path based on three-dimensional analytics: U.S. Pat. No. 7,864,019 (the '019 Patent); and PCT Application Number PCT/US 13/73749 “Wiring Assemblies and Methods of Forming Channels in Wiring Assemblies” filed 6 Dec. 2013 (the '749 Patent), which is based on U.S. Provisional Patent Application No. 61/734,116 (the '116 Application). Accordingly, a conductor may be conformed to a wiring path defined by the groove. In prior art coil designs it is known to form such a groove with “V” shaped side walls or with spaced-apart parallel side walls which provide a “U” shape, or other groove shapes, e.g., semicircular profiles. Generally the possible wire shapes in cross section include circular, rectangular or ribbon-like profiles.

In an exemplary fabrication sequence a groove is formed in a support structure and the conductor is placed within the groove. The support structure may comprise a resin composite outer layer which has been machined or cast to provide a groove into which the conductor is inserted. Once the conductor is so placed an overcoat of resin can be applied over the conductor to fill the groove. Subsequently, a new outer layer of resin composite material may be formed over the layer in which the groove has been formed in order to initiate a process in which a second groove is formed for placement of conductor over the conductor which has been inserted in a first groove. This is one of several known approaches for creating concentric layers of conductor coil in spaced-apart cylindrical planes defined for Double Helix and saddle coil configurations. The cylindrical planes may be circular or elliptical in shape or have other shapes.

These and other fabrication sequences may also be adapted to form a groove in a metal or metal composite support structure. Accordingly, the outer exposed surface of the conductor may be coated with an electrically insulating layer, or an insulative material may be wrapped thereabout. Generally, however, depending on the fabrication process, after the conductor is placed in the groove and the fabrication process is completed, the stability of the wire may vary under large Lorentz forces present when current travels through the conductor winding. This is of particular concern with applications of superconducting magnetic coils because heat generated by very small movements of the wire can cause the wire to exceed the characteristic critical temperature T_{c} of the wire and, possibly, damage the winding structure. A need exists for a wiring system and associated structure which more fully stabilizes a conductor positioned within a groove when in the presence of large Lorenz forces.

### SUMMARY OF THE INVENTION

According to an embodiment of the invention a wiring assembly includes a support structure having a surface region about a central axis, with a groove, formed in the surface region. The groove has first and second opposing wall portions each extending inward toward the central axis. The wall portions may impart a V shape to the groove. A coil winding comprises a length of conductor positioned in and extending along the groove. A sheet of material is positioned about a portion of the conductor. The sheet may include first and second opposing sides, with the first side facing the conductor and the second side facing at least one of the groove surface portions. A continuous medium extends from each of the groove wall portions toward the sheet. The continuous medium may extend to the sheet. The continuous medium may provide stabilization of the conductor in the presence of Lorentz forces exceeding, for example, 10,000 N/m. The support structure may be an insulative body and the continuous medium may comprise a cured resin.

In one example, the sheet comprises fabric and the first continuous medium extends from at least one of the groove surface portions, through the fabric, and to the conductor. In another example, the sheet of material may be a polymer in the form of a tape wrapped about the length of conductor. Polymer on the first side of the sheet of material may be in direct contact with the conductor. The first side of the sheet of material may not be bonded to the conductor. When the first side of the sheet of material and the conductor are in physical contact along an interface, this may permit slippage between adjoining surfaces.

### BRIEF DESCRIPTION OF THE FIGURES

FIG. 1 is a partial view in cross section of a structure comprising a wiring system according to one embodiment of the invention;

FIGS. 2A-2D illustrate in cross section a series of fabrication steps for coil rows in the structure of FIG. 1, with:

FIG. 2A illustrating a view of a coil row showing a groove having coating of resin formed therein;

FIG. 2B illustrating a wire and fabric material positioned about a portion of the conductor in the form of a sleeve;

FIG. 2C illustrating the groove filled with resin; and

FIG. 2D illustrating a second coil row formed in the structure of FIG. 1;

FIG. 3 is a view taken along a surface of a woven cloth to illustrate a section of exemplary fabric material;

FIG. 4A illustrates another a wiring system according to the invention, in simplified schematic form, comprising a wire in the shape of a quadrilateral, wrapped with a woven material and placed in a coil row groove;

FIGS. 4B and 4C illustrate another wiring system according to the invention, in simplified schematic form, comprising a ribbon conductor positioned along one of two side wall portions of a coil row groove; and

FIG. 4D illustrates still another wiring system according to the invention, again in simplified schematic form, where multiple segments of conductors are positioned alongside one another in a coil row groove;

FIGS. 5A-5C illustrate features of a first embodiment of a wiring assembly in which a polymer material provided in tape form is positioned about a portion of a conductor, where:

FIG. 5A is a side view illustrating a partially cured resin coating on a surface of the polymer tape;

FIG. 5B is a perspective view of the polymer tape being spiral wrapped about a segment of the wire; and

FIG. 5C is a partial view in cross section of the completed wiring assembly showing the wire wrapped with the polymer tape positioned in the groove with cured resin having effected stabilizing bonds with the wire, the tape and walls of the groove; and

FIGS. 6A-6B illustrate features of a second embodiment of a wiring assembly in which a polymer material provided in tape form is wrapped about a portion of conductor in the form of a wire, without being bonded to the wire, where:

FIG. 6A is a perspective view of the polymer tape being spiral wrapped about a segment of the wire; and

FIG. 6B is a partial view in cross section of the completed wiring assembly showing the wire wrapped with the polymer tape positioned in the groove with cured resin having effected stabilizing bonds with an outer surface of the tape and with walls of the groove.

To facilitate understanding of the figures, like reference numbers are used to describe like features throughout. To emphasize features more relevant to the invention and for simplicity of illustration, various ones of the described features are not drawn to scale.

### DETAILED DESCRIPTION OF THE INVENTION

Before describing in detail the particular methods and features relating to the invention, it should be observed that the present invention resides primarily in a novel and non-obvious combination of elements and method steps. So as not to obscure the disclosure with details that will be readily apparent to those skilled in the art, certain conventional elements and steps have been presented with lesser detail, while the drawings and the specification describe in greater detail other elements and steps pertinent to understanding the invention. The following embodiments are not intended to define limits as to the structure or method of the invention, but only to provide exemplary constructions. The embodiments are permissive rather than mandatory and are illustrative rather than exhaustive.

Also, to more clearly define the scope of inventive subject matter, certain terms are defined. The term bonded means, with respect to two components, that one component is joined, attached, fastened, confined or constrained, with respect to the other component (e.g., mechanically or chemically), providing a degree of mechanical stabilization that limits or prevents movement of one component with respect to the other component. The term wire references any type of conductor suitable for use in practicing the concepts described herein, and the term is not limited to types of wire formed by extrusion and the like. The term wire includes all high temperature superconductors, including YBCO.

Also, as used herein, the term Continuous Medium means one or more media where each medium has one or more continuous portions (e.g., at least a first continuous medium which extends continuously between two features such as between a groove surface and a sheet of fabric, or between a groove surface and a conductor). Thus a Continuous Medium may comprise multiple continuous media, each extending continuously between a pair of features. By way of example, a Continuous Medium may include three continuous media, with (i) the first continuous medium extending from a first groove surface portion to a sheet, (ii) the second continuous medium extending from a second groove surface portion to the sheet, and (iii) the third continuous medium extending between the sheet and a wire.

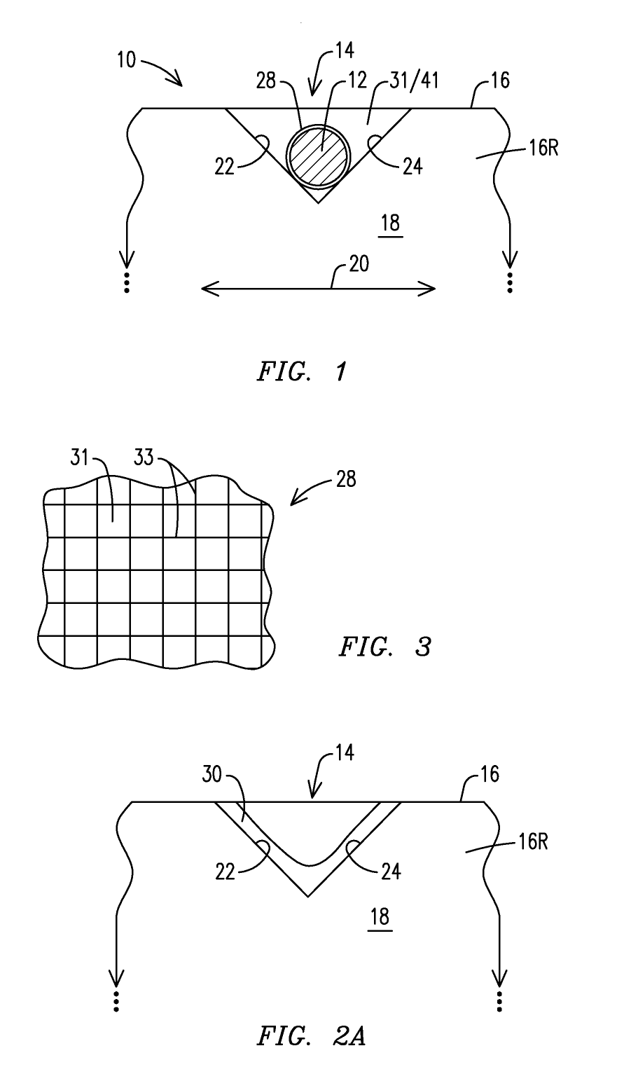

FIG. 1 is a view in cross section of a portion of a wiring system 10 for a coil winding in which a coil wire 12, also referred to as a length of conductor, is positioned in a V-shaped groove 14₁ formed along a surface 16 of a support structure 18. The surface 16 is formed about a central axis 20 and along a surface region 16R which extends away from the surface, e.g., inward toward the central axis 20. The surface region 16R generally adjoins the surface 16. In numerous embodiments the surface 16 is of a cylindrical shape positioned symmetrically about a central axis. See, again, the '019 Patent. The wire 12 is shown in the figures to have a circular shape in cross section, but this is only exemplary and numerous other shapes are suitable. Although not fully illustrated, the support structure could be a cylindrically-shaped body containing a first coil row CR₁ (comprising the wire 12) formed in the groove 14ₖ, which groove follows a predefined three-dimensional space curve describing the paths of the regular helical geometries. The space curve may be in accord with the relationship

X(θ)=[h/(2*π)]θ±A*sin(nθ)

Y(θ)=R*cos(θ)

Z(θ)=R*sin(θ)

wherein coil rows CRᵢ in alternating ones of a plurality of cylindrical planes follow paths for which the Asin(nθ) term is added or subtracted. See the '019 Patent. That is, the wiring system may comprise multiple layers of coil rows, CRᵢ, each comprising a groove to form a concentric configuration of grooves 14, about the axis 20, e.g., each groove 14, residing in a different cylindrical plane Pᵢ. The exemplary groove 14₁ illustrated in FIG. 1 has first and second opposing wall portions 22, 24 extending from the surface toward the axis 20. As described in the '749 Patent, multiple segments of the coil wire 12 may be stacked in a single groove 14₁ and the shape of any groove 14, may vary from the variety of shapes described herein or shown in the figures.

According to one embodiment of the invention, the material 28 is an insulative layer surrounding a substantial portion of or all of the coil wire 12 along a length of the wire. The coil wire 12 may be wrapped with the material 28 or the material 28 may be in the form of a tube or a sleeve positioned about the wire 12. In either case, the material 28 may be formed as braided fibers or as a cloth having a conventional fiber weave. When the material 28 is formed in the shape of a tube or sleeve, the installed material 28 may be positioned about the exterior of the wire 12 so that the insulative material covers the wire 12 without forming a seam about the perimeter of the conductor shape in cross section.

On the other hand, an embodiment utilizing a cloth formed with a conventional weave may be placed or wrapped partly or completely about the wire 12, e.g., like a coil or like wound tape. After positioning of the wire 12 and the material 28 in the groove 14₁, a substantial portion of the groove is filled with an uncured resin 30 to surround the material 28. The uncured resin 30 can wick into the interstices of the material 28 or otherwise coat the fibers of the material and then cure into a solid resin body 31 to create a medium 41 which further stabilizes the wire 12 in the presence of Lorentz forces. While not necessarily required for all embodiments of the invention, for superconducting applications the cured resin 41 is a cryogenically qualified epoxy resin.

Although this and other embodiments describe the medium as comprising a resin body, the medium 41 used in the illustrated embodiments may comprise other materials and may, for example, be a ceramic body. Also, although not expressly shown in the figures, it is to be understood that with portions of the material 28 positioned against the first and second opposing wall portions of a groove 14ᵢ, a thin layer of the resin or other medium material may reside along the interface between the material 28 and each of the wall portions, e.g., portions 22, 24. To facilitate wicking or other movement of the uncured resin 30 into the interstices of the insulative material 28, the resin 30 may have a low viscosity when applied, e.g., similar to the viscosity of water, to enable penetration into voids. In some instances, the resin viscosity may be varied by changing temperature or pressure. The resin viscosity at room temperature, under normal atmospheric conditions, may be comparable to that of a resin typically used in vacuum impregnation processes or that of water.

The material 28 may, but need not, be predominately or entirely insulative, and may comprise glass fibers such as commonly used to form resin composites. Numerous other materials used to form a cloth or braided fiber arrangement (e.g., ceramic or Kevlar) have suitable properties to provide a bond between the cured resin and the wrapping of material 28. Such a low viscosity resin may be curable based primarily on time and temperature, or may be of the type which cures based primarily on an exothermic reaction (e.g., a two part epoxy resin system).

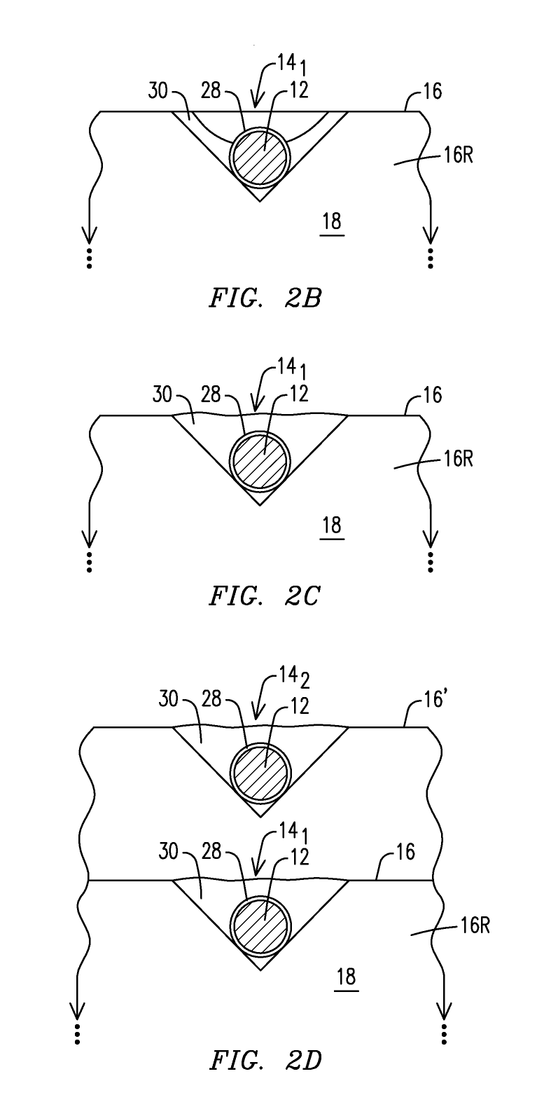

With reference to FIGS. 2, a brief sequence of exemplary steps for fabricating the wiring system 10 begins with initially coating at least a lower portion of the groove 14₁ with uncured low viscosity resin 30 and partially filling the groove with the resin 30. See FIG. 2A. In this example, the material 20 comprises an insulative cloth. With the wire 12 already surrounded with the insulative material 28, the wire 12 and material 28 are inserted within the groove to come into contact with the initial coating of uncured resin 30 so the uncured resin 30 begins wicking into interstices 31 of the woven material and contacting the fiber 33 of the material or wetting the insulative material 28. FIG. 3 is a partial view of a section of the material 28 showing fibers 33 crossing one another.

The initial coating of resin material 30 may be of such minor depth that, upon insertion of the wire 12, only a portion of the wire and a portion of the associated wrapping of insulative material 28 come into contact with the resin 30. See FIG. 2B. On the other hand, the initial coating of resin may completely fill the groove, e.g., the groove 14₁ to such depth that, upon insertion of the wire 12, the entire wire and associated wrapping of insulative material may be substantially or entirely submerged in the resin 30 so that the initial coating of resin material 30 provides a coating which envelops a segment of the wire 12 and completely surrounds the wrapping of material 28. See FIG. 2C. However, if the initial coating of resin material 30 is of such minor depth that only a portion of the wrapping of material 28 comes into contact with the resin 30, then additional resin 30, e.g., a higher viscosity resin) may be placed in the groove 14₁ to completely fill the groove, again as shown in FIG. 2C. At this point in the fabrication process the resin 30 may become partially or fully cured. For example, with thermal cure processing, a partial cure may be performed after each coil row CRᵢ is fabricated, while a full cure is effected after a complete multi-layer structure having multiple coil rows is formed. It is believed that optimal stabilization of the wire 12 can be achieved by completely filling each groove 14, with the resin 30, or at least by completely submerging the wire 12 and the material 28 in the resin 30. In other embodiments, the groove may not need to be completely filled with the resin and the material 28, which may be insulative, may not need to be completely surrounded with the uncured resin 30.

The material 28 may be in the form of a woven cloth tube that is slipped over the wire 12 or a sheet which is wrapped, e.g., in a spiral configuration, about the wire 12. The material 28 may also be formed as strips, having a narrow width relative to the strip length, and wound about the wire 12 in a spiral wrap configuration, e.g., like a winding of tape. The exemplary woven cloth used for the material 28 has first and second opposing major surfaces 28₁, 28₂. When the cloth is wrapped about the wire 12, the first surface 28₁ faces toward the wire 12 and the second surface 28₂ faces away from the wire 12. The material 28 may be provided in the form of a pre-impregnated composite fiber (referred to herein as a pre-preg). A coating 30_{PCR} of Partially Cured Resin (PCR) may be formed along the first major surface 28₁ of the material, which surface faces the wire 12. With any of these configurations a material 28, comprising woven cloth, may be applied in combination with additional resin to form the configuration shown in FIG. 1.

Subsequently, if the wiring system 10 contains multiple coil rows CRᵢ, e.g., formed in different cylindrical or elliptical planes, Pᵢ, the fabrication sequence includes forming a sufficient quantity of additional resin composite material about the surface 16 to extend the structure 18 illustrated in FIG. 1 radially outward to define another surface 16′ (e.g., concentric with the plane in which the groove 14₁ is formed); and forming a second groove 14₂ in the surface 16′ of the newly added composite material in order to provide a second coil row CR₂ in a manner like that described for formation of the first coil row CR₁. See FIG. 2D. The process may be repeated to provide a larger plurality of concentric coil rows CRᵢ. In other embodiments, the material 28 wrapped about the wire 12 may be or comprise pre-impregnated composite fiber referred to as a pre-preg, i.e., having a matrix of resin material incorporated in or about the weave or braiding.

For numerous embodiments, with the material 28 formed of fibers, coating the material 28 with Partially Cured Resin (PCR), or formation of the material 28 as a pre-preg, can facilitate formation of a stabilizing matrix for the wire 12 inserted in the groove 14ᵢ, while the material 28 retains sufficient flexibility for shaping about the wire 12 and for insertion of the wire 12 and the material 28 into the groove 14ᵢ. B-stage materials are exemplary, but these commonly require cold storage to retard the cure process while substantial heating may be required to complete the polymerization process.

When the material 28 is a pre-preg serving as a matrix precursor about the fibers, the fibers may extend in only one direction or may be formed in one or more layers of chopped fibers. When the material 28 is formed as an insulative pre-preg material, there may be sufficient resin in the material that the above-noted step (shown in FIG. 2A), in which the lower portion of a groove 14, is coated with uncured resin material before inserting the wire 12, need not be performed. That is, if there is sufficient pre-preg resin formed about the material, the pre-preg resin can come into contact with the walls of the groove such that the lower portion of a groove 14, need not be coated with uncured resin material before inserting the wire. Also, it may be advantageous to initially use a resin having a relatively low viscosity (e.g., comparable to that of water) to wet the wire 12 and the material 28, and then to fill the groove 14, with a resin having the same viscosity or a higher viscosity.

Embodiments of the fabrication process have been described with a woven layer of cloth selected as the material 28 and allowing resin to fill voids between the wire 12 and the material 28 or to fill interstitial voids in the woven layer. In other embodiments the material 28 may be a continuous, non-woven layer and may be in direct contact with the wire 12 instead of being spaced apart from the wire by an intervening medium such as an epoxy resin. By way of example the material 28 may be a flexible polymer layer in the form of a sheet or a foil having a thickness on the order of 0.5 mil (0.0127 mm) to 2 mil (0.0508 mm). A flexible polymer sheet or a foil comprising a polyimide film may be used in lieu of a woven fabric. Such a sheet or foil may be perforated, thereby allowing low viscosity resin to penetrate voids in a manner analogous to the way the resin 30 can extend through fabric interstices 31to facilitate mechanical stabilization of the wire 12 in a groove 14ᵢ. On the other hand, a polymer sheet may be impervious and used to provide a slip plane or interface that permits low friction movement of the wire 12 relative to the material 28.

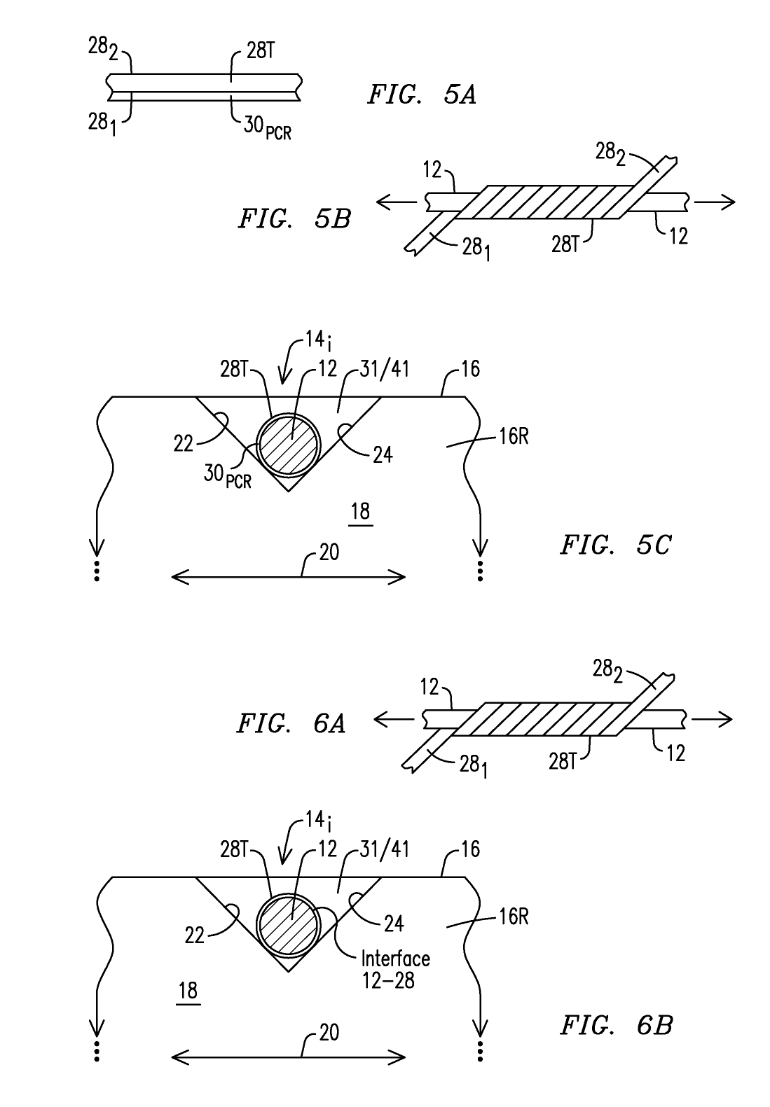

FIGS. 5 illustrate features of an embodiment of a wiring assembly in which the material 28 is formed as polymer. The polymer may be in the form of (i) a tube or casing placed about the wire 12, (ii) a sheet which is wrapped about the wire 12 (e.g., a coil or spiral wrap) or (iii) a tape. As shown in FIG. 5A, the material 28 is in the form of a polymer tape 28T (e.g., a polyimide) which can be spiral wrapped about the wire 12 as shown in FIG. 5B. With the material 28T having first and second opposing major surfaces 28₁ and 28₂, a coating 30_{PCR} of Partially Cured Resin (PCR) is formed along the major surface 28₁. See FIG. 5A. The resin coating or layer 30_{PCR} faces the wire 12 when the tape 28T is wrapped about the wire 12 (e.g., as a spiral tape winding). See the view of FIG. 5B which shows a segment of the wire 12 partially wrapped with the tape 28T. Because the resin coating on the tape 28T is not fully cured before the tape 28T is installed in the groove 14ᵢ, the wire 12 wrapped with the tape 28T retains sufficient flexibility to be placed in a groove 14ᵢ. Prior to placement of the wrapped wire in a groove 14ᵢ, the groove may receive a coating of resin 30 along at least a lower portion, including along first and second opposing wall portions 22, 24, as illustrated in FIG. 2A for an earlier described embodiment. The wire 12 wrapped with the partially cured resin-coated tape 28T is then placed in the groove 14ᵢ. After placement of the wrapped wire in the groove 14ᵢ, additional uncured resin 30 may be placed in the groove 14ᵢ to completely fill the groove. Upon curing, the resin 31 bonds the polymer along the major surface 28₁ to the wire 12. The cured resin 31 establishes stabilizing bonds with the wall portions 22, 24 and the tape 28T wrapped about the wire 12. The completed structure is shown in FIG. 5C.

FIGS. 6 illustrate features of another embodiment of a wiring assembly in which the material 28 predominantly comprises a polymer. As discussed for the embodiment of FIG. 5, the polymer may be in the form of a tube or casing placed about the wire 12, a sheet which is wrapped about the wire 12 (e.g., a coil or spiral wrap) or a tape. FIGS. 6 illustrate the polymer in the form of a tape 28T (e.g., a polyimide) which can be spiral wrapped about the wire 12.

With the material 28T having first and second opposing major surfaces 28₁ and 28₂, the tape 28T is wrapped about the wire 12 (e.g., as a spiral tape winding). See the view of FIG. 6A which shows a segment of the wire 12 partially wrapped with the tape 28T. The first surface 28₁ is in direct contact with the wire 12 along a wire-tape interface 12-28. A feature of this embodiment is that the tape 28T is not bonded to the wire 12. Rather, the wire can experience low friction movement along the interface 12-28. To otherwise stabilize the wire 12 in the groove, the groove 14, may receive resin 30 before and after the wire is placed therein. For example, prior to placement of the wrapped wire 12 in the groove 14ᵢ, the groove may receive a coating of resin 30 along at least a lower portion, including along first and second opposing wall portions 22, 24, as illustrated in FIG. 2A. The wire 12 wrapped with the tape 28T is then placed in the groove 14ᵢ. After placement of the wrapped wire in the groove 14ᵢ, additional uncured resin 30 may be placed in the groove 14, to completely fill the groove. Upon curing, the polymer along the major surface 28₂ is bonded to the cured resin 31 and the cured resin 31 is bonded to the groove wall portions 22, 24, this stabilizing the wire 12 while permitting the wire to undergo minor, low friction movements along the interface 12-28, which movements may occur due to temperature cycling or large Lorentz forces acting on the wire 12. The completed structure is shown in FIG. 6B.

The embodiments illustrated in FIGS. 5 and 6 are exemplary of wiring assembly designs providing a stabilizing matrix about the material 28 when the material is a non-woven layer. The material 28, in the form of a polymer such as a polyimide can also remain sufficiently flexible for shaping about the wire 12 and insertion with the wire into a groove 14ᵢ. An exemplary polyimide suitable for the embodiments of FIGS. 5 and 6 is sold by E. I. du Pont de Nemours and Company (the Dupont Company) under the trade name Kapton. Kapton is a registered trademark of the Dupont Company. The choice of a non-woven layer for the material 28 may include a material having a sublayer or coating 30_{PCR} of partially cured resin along a surface thereof. When the non-woven layer includes perforations the material 28 may be formed as a pre-preg, with, for example, B-stage materials, although B-stage materials commonly require cold storage to retard the cure process while substantial heating may be required to complete the polymerization process. Also, with the material 28 comprising a polymer, e.g., a polyimide, any fibers included in the material need not be in a woven or braided pattern, regardless whether the material 28 comprises pre-preg material or comprises a coating 30_{PCR} of partially cured resin.

For embodiments according to the invention, after the wire 12 is placed in a groove 14i, and the groove is filled with curable resin, that resin may undergo curing at the same time as curing of a previously inserted low viscosity resin or pre-preg material in the same groove or in another groove, e.g., a groove in a different coil row CRᵢ. All of the above-noted embodiments may incorporate vacuum impregnation during formation of the coil rows CRᵢ.

Regardless whether the material 28 comprises a weave or is a continuous material such as a sheet of polymer, use of pre-preg or a coating 30_{PCR} of partially cured resin can facilitate formation of, and enhance the strength of, a bond between the resin 30 and the material 28. FIGS. 5 and 6 have illustrated select steps in a fabrication sequence suitable for employing the material 28 in the form of a polymer, such a sheet or layer, e.g., a tape 32, optionally having a sublayer or a coating 30_{PCR} formed on one or both sides 28₁ and 28₂ of the sheet.

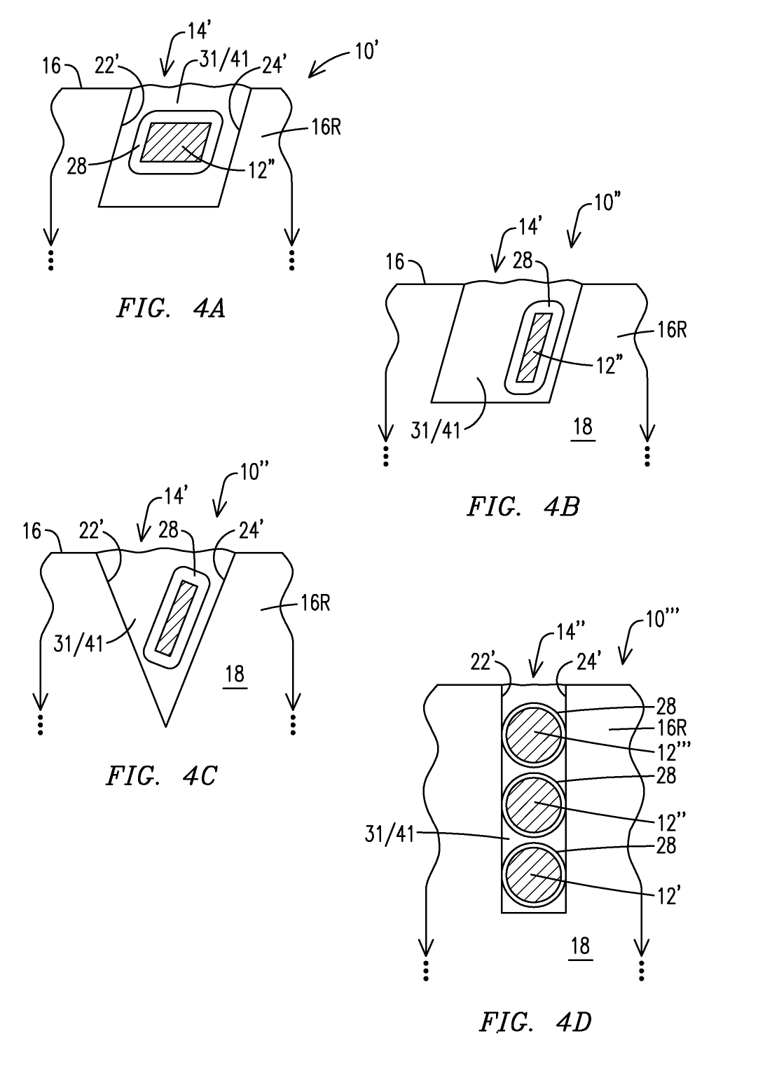

In one embodiment, after the groove is filled with curable resin, that resin may undergo curing at the same time as curing of a previously inserted low viscosity resin or pre-preg material. All of the above-noted embodiments may incorporate vacuum impregnation during formation of the coil rows CRᵢ. The vacuum impregnation process may introduce additional resin to assure that a groove 14, including all interstices about the insulative material 28 and the wire 12 are completely filled with resin and assure optimal stabilization of the wire 12 under large Lorentz forces, e.g., exceeding 10,000 N/m. The vacuum impregnation step also facilitates effecting a strong bond between the resin and each surface it contacts, e.g., a wall of the groove and the insulative material, and bonding of the resin directly to the wire 12 or any coating formed on the wire 12 or on the material 28. Placement of the material 28 about the wire 12 may be relied upon for strengthening the structure formed in the groove 14, including the bonds at all interfaces, for enhanced wire stabilization in the groove, whether or not there is a coating on the wire which enhances insulative properties of the wire 12. Bonds which strengthen the structure may include the bond between the continuous medium (e.g., the resin 31) and the material (e.g., a sheet of fabric), the bond between the continuous medium and the conductor wire 12, and the bonds between the continuous medium and each of the opposing groove surface portions. The concepts disclosed herein may be applied to a variety of groove designs and wiring architectures. See, for example, FIGS. 4 through 7 of the '019 Patent which discloses insertion of a wire having a more or less rectangular shape in a groove having parallel side walls. The groove may also accommodate multiple layers of wire, each layer positioned in a different cylindrical plane. See, again, the '749 Patent. FIGS. 4A through 4D are exemplary of numerous wire assembly designs in which the invention may be practiced.

As shown in FIG. 4A, a wiring system 10’ comprises a wire 12′ in the shape of a quadrilateral, e.g., having a rectangular-like shape, placed in a groove 14′. The groove 14′ is in the general or approximate shape of a “U” and is illustrated as an open quadrilateral, i.e., in a shape similar to that of a parallelogram but having three sides instead of four sides formed in the support structure 18. More generally, the groove 14′, when viewed in cross section has opposing and spaced-apart side wall portions 22′, 24′. In this example, the opposing side walls include side wall portions 22′, 24′ which are parallel to one another. That is, a portion of each opposing wall may be parallel to a portion of the other wall without the entireties of the two opposing walls being completely parallel to one another. Insulative material 28, in a form corresponding to one of the afore described examples, surrounds much or all of the wire 12′.

FIGS. 4B and 4C illustrate a wiring system 10″ comprising a ribbon conductor 12″, e.g., a high temperature superconductor such as YBCO tape, positioned along one of two side wall portions 22′, 24′ of a groove. The groove 14′ illustrated in FIG. 4B is exemplary, and the groove may be an afore described V-shaped groove 14 or may be in the shape of an open quadrilateral or a U-shape.

FIG. 4D illustrates a wiring system 10″' where three segments of wire 12′, 12″ and 12″' are formed one over another to create a stack of conductors in a groove 14″, similar to an arrangement described in the '749 Patent. Each segment of wire includes insulative material 28 wrapped about the wire segment. The groove 14″, although illustrated as U-shaped, may be of a variety of shapes and, if the groove 14″ is a V-groove, the segments of wire may be stacked in other configurations such as that of a triangle.

The inventive concepts which have been disclosed can be practiced with grooves accommodating additional features such as cooling channels and with the wire 12 formed of numerous materials including superconducting materials and multi-filament conductors, which are preferred for AC operations since AC losses in superconductors and skin effects in normal conductors are reduced with small filaments. The afore described fabrication sequences may be applied to form a groove in a metal or metal composite support structure. This may be facilitated with vacuum impregnation of additional resin or application of pressure. With application of the concepts disclosed, the potential for movement of wire is significantly reduced.

It is conventional to manufacture the conductor support structure 18 with fiberglass-reinforced composites and machined grooves as disclosed in the '019 Patent, and with epoxy resins qualified for cryogenic applications. The support structure 18 may also be fabricated entirely with ceramic materials. While casting processes may be suitable for some applications, the support structure 18 may best be fabricated with a ceramic of the type in which conductor support grooves of various shapes, as shown in the figures, can be machined. The machinable structure 18 may comprise fiber reinforced ceramic to increase the material strength and impede micro cracking. For many, if not all embodiments of the invention, in lieu of incorporating a curable epoxy the resin 30, a low viscosity ceramic putty may be applied in like manner to the afore described application of the curable resin 30 and then fired to create a medium 41 which further stabilizes the wire 12 in the presence of Lorentz forces.

Based on selection of ceramic materials, the described technology is applicable to wind-and-react coil manufacturing as needed for brittle superconductors such as Nb₃Sn and MgB₂. Ceramic materials provide as an additional advantage to coil windings a Coefficient of Thermal Expansion (CTE) more closely matched to the CTE of metallic conductors than other materials such as conventional epoxy resins, a consideration relevant to operation of large superconducting coils which may undergo temperature cycling as required for low temperature operations. Some ceramic materials with significant thermal conductivity enable relatively efficient heat transfer out of the coil, relevant in applications that deposit energy into the conductor, which occurs in superconducting AC applications.

Numerous embodiments of a wiring assembly have been described which can improve stabilization of a conductor in the presence of large Lorentz forces. It should be noted that the inventive concepts are advantageous for securing conductors having small areas in cross section in the presence of small or large Lorentz forces, as well as larger conductors which experience larger Lorenz forces in rotating machinery and research magnets. The invention is useful in a wide variety of superconducting applications, including rotating machinery. The invention may be advantageously used in applications where multiple segments of a conductor winding are placed in the same groove, whether they are arranged along a plane about which the groove is formed or stacked within the groove. Further, the wiring assembly may comprise multiple levels of grooves each, for example, spaced apart in different cylindrical planes. Those skilled in the art will recognize that use of the materials disclosed herein is merely exemplary while numerous substitutions to improve performance will be apparent. For example, modifications to or substitutions for the resin used to create a stabilized structure, in conjunction with a material comprising a weave of fiber material, may further stabilize the structure and can render the system more robust after repeated temperature cycling.

The examples used to describe fabrication of the invention describe the invention in a simplest form while it will be apparent to persons skilled in the art that numerous commercial embodiments will employ additional features that enhance performance such as, for example, cooling channels and in situ formation of conductor. Other exemplary design features are disclosed in PCT/US 13/73749, “Wiring Assemblies and Methods of Forming Channels in Wiring Assemblies” incorporated herein by reference. Numerous additional modifications will be apparent to those skilled in the art. Accordingly the scope of the invention is only limited by the claims which now follow.

1. A wiring assembly comprising:
a support structure having a surface region about a central axis, with a groove, formed in the surface region, having first and second opposing surface portions each extending inward toward the central axis;
a coil winding comprising a length of conductor positioned in and extending along the groove;
a sheet of material positioned about a portion of the conductor, the sheet including first and second opposing sides, the first side facing the conductor and the second side facing at least one of the groove surface portions; and
a first continuous medium, extending from one of the groove surface portions to the sheet.

2. The wiring assembly of claim 1 wherein:
the sheet comprises fabric and the first continuous medium extends from at least one of the groove surface portions, through the fabric, and to the conductor.

3. The wiring assembly of claim 1 wherein:
the sheet comprises fabric and the first continuous medium extends from at least the first groove surface portion, through the fabric, to the conductor and to the second groove surface portion.

4. The wiring assembly of claim 1 including a Continuous Medium comprising:
(i) the first continuous medium which extends from the first of the groove surface portions to the sheet;
(ii) a second continuous medium extending from the second of the groove surface portions to the sheet; and
(iii) a third continuous medium extending from the wire to the sheet.

5. The wiring assembly of claim 1 wherein the sheet comprises a fabric and the first continuous medium extends from each of the first and second opposing groove surface portions through the fabric and to the conductor.

6. The wiring assembly of claim 1 wherein the first continuous medium provides stabilization of the conductor in the presence of Lorentz forces.

7. The wiring assembly of claim 1 wherein the sheet of material is a polymer.

8. The wiring assembly of claim 7 wherein the sheet of material is a polymer in the form of a tape wrapped about the length of conductor.

9. The wiring assembly of claim 1 wherein:
the sheet of material comprises a polymer wrapped about the length of conductor;
the first side of the sheet of material facing the conductor includes the polymer; and
the polymer on the first side of the sheet of material is in direct contact with the conductor.

10. The wiring assembly of claim 9 wherein the first side of the sheet of material is not bonded to the conductor.

11. The wiring assembly of claim 9 wherein the first side of the sheet of material and the conductor are in physical contact along an interface which permits slippage between adjoining surfaces.

12. The wiring assembly of claim 9 wherein the sheet of material is in the form of a tape wrapped about the conductor.

13. The wiring assembly of claim 1 wherein:
the sheet of material comprises a polymer wrapped about the length of conductor; and
at least a portion of the sheet of material is spaced away from the conductor, the assembly further including a second continuous medium extending from the conductor to the first side of the sheet of material.

14. The wiring assembly of claim 13 wherein the second continuous medium is bonded to the first side of the sheet of material.

15. The wiring assembly of claim 7 wherein the sheet of material is a polyimide film.

16. The wiring assembly of claim 1 wherein:
the sheet of material is a polymer in the form of a tape wrapped about the length of conductor; and
the first continuous medium is bonded to the sheet of material and one of the groove surface portions.

17. The wiring assembly of claim 1 wherein the continuous medium provides stabilization of the conductor in the presence of Lorentz forces exceeding 10,000 N/m.

18. The wiring assembly of claim 1 wherein the continuous medium comprises a cured resin.

19. The wiring assembly of claim 1 wherein the wiring assembly includes one or more bonds taken from the group consisting of: a bond between the continuous medium and the sheet, a bond between the continuous medium and the conductor, and a bond between the continuous medium and one of the first groove surface portions.

20. The wiring assembly of claim 1 wherein the sheet is in the form of a sleeve surrounding the portion of the conductor.

21. The wiring assembly of claim 1 wherein the sheet positioned about a portion of the conductor is insulative.

22. The wiring assembly of claim 1 wherein the sheet positioned about a portion of the conductor comprises braided fibers or is formed as a woven cloth.

23. The wiring assembly of claim 1 wherein the first continuous medium comprises a cryogenically qualified epoxy resin.
